(19) United States
(12) Patent Application Publication
(10) Pub. No.: US 2007/0204534 A1
(43) Pub. Date: Sep. 6, 2007

(54) DOORFRAME

(75) Inventors: Li Lin, Shanghai (CN); Jian Liu, Shanghai (CN); Wenli Kang, Shanghai (CN)

Correspondence Address: LOWE, HAUPTMAN, GILMAN & BERNER, LLP (ITW), 1700 DIAGONAL ROAD, SUITE 300, ALEXANDRIA, VA, 22314, US

(73) Assignee: PREMARK RWP HOLDINGS, INC., Wilmington, DE (US)

(21) Appl. No.: 11/573,780

(22) PCT Filed: Aug. 16, 2005
(86) PCT No.: PCT/US05/29061

§ 371 Date: Feb. 15, 2007

(30) Foreign Application Priority Data
Aug. 16, 2004 (CN) 200410053777.0

(51) Int. Cl. E06B 1/52

(52) U.S. Cl. 52/204.1

(57) ABSTRACT

A doorframe assembly includes a doorframe post front portion (202), a doorframe post rear portion (204) and a doorframe post middle portion (207). These three doorframe post portions can be installed into wall-bodies (10) having different thicknesses. Each of the three doorframe post portions has an L-shaped transverse section. The L-shaped transverse section has two arcs around its two corners so that a sheet of fire-resistant decorative laminate (or high pressure decorative laminate) can be adhesively amounted around the outside surface of the L-shaped transverse section.

### FIELD OF THE INVENTION

This invention generally relates to a doorframe, and more specially, relates to a doorframe that can be installed into a wall-body as an assembly after the wall-body has been built.

### BACKGROUND OF THE INVENTION

In constructing residential and commercial buildings, a doorframe is usually installed into a doorway on a wall-body after the wall-body is completely built. Traditionally, the width of a doorframe is fixed and cannot be adjusted. Therefore, to fit wall-bodies having different widths, some doorframes need to be specifically ordered or manufactured in advance for these wall-bodies after designs of the buildings have been completed. The situation would be more troublesome when the widths of some wall-bodies in a building are determined or adjusted during construction. In this situation, some doorframes have to be specially ordered or manufactured for the wall-bodies during construction or after completion of the wall-bodies, thus increasing manufacturing complexity and manufacturing cost and delaying construction progress.

In addition, traditional doorframes have shortcomings in some design aspects, which cause manufacturing complexity and may have some negatively effects on the artistic appearance and on the use safety of the doorframes.

### SUMMARY OF THE INVENTION

One objective of the invention is to provide a doorframe as an assembly with its width being able to be adjusted to fit wall-bodies having different thicknesses.

Another objective of the invention is to improve the structure of doorframes to simplify the manufacturing and installation process and improving the artistic appearance and their use safety of the doorframes.

According to the present invention, a doorframe assembly (100) for being mounted into a wall-body (10) comprises a left doorframe post (102), a right doorframe post (104) and a transverse doorframe post (106). Each of the three doorframe posts (102, 104, 106) further comprises a doorframe post front portion (202) having an L-shaped transverse section; a doorframe post rear portion (204) having an L-shaped transverse section; a doorframe middle portion (207) having a T-shaped transverse section; wherein the wall-body (10) has a doorway (12) defined by a front wall-body (212), a rear wall-body (214) and a side wall-body (216); wherein the doorframe post front portion (202) is mounted around the corner at the joint section of the front wall-body (212) and the side wall-body (216); wherein the doorframe post rear portion (204) is mounted around the corner at the joint section of the rear wall-body (212) and the side wall-body (216); and wherein the doorframe post middle portion (205) is installed between the doorframe post front portion (202) and the doorframe post rear portion (206).

In comparison with the prior art, the doorframe assembly (100) can be adjusted fitting to wall-bodies having different thicknesses.

### BRIEF DESCRIPTION OF THE DRAWINGS

Those skilled in the art can clearly understand the above-mentioned objectives, the technical problems to be solved, the technical features and other aspects of the invention through the following specific embodiments in combination with the following accompanying drawings:

FIG. 1A is a perspective view of a wall-body 10 having a doorway 12;

FIG. 1B a perspective view of a doorframe 100, which is installed in the doorway 12 of the wall-body 10 according to the present invention;

FIG. 1C is a front view of the doorframe 100 and the door 108 installed within the doorframe 100 to show a left doorframe post 102, a right doorframe post 104 and a transverse doorframe post 106 according to the present invention;

FIG. 2A is a section view along section line A-A in FIG. 1C;

FIG. 2B is a section view along section along line B-B in FIG. 1C;

FIG. 3A shows the transverse section view of a doorframe section 302 in prior art;

FIG. 3B shows the transverse section view of doorframe post front portion 202 or doorframe post rear portion 204 of a doorframe post 102, 104 or 106;

FIGS. 4A, 4B, 4C and 4D are the assembling diagrams for the doorframe according to the present invention;

FIG. 5 shows a perspective view to show the door 108 and the doorframe 100 to be installed in the doorway of the wall-body in accordance with the invention; and

FIGS. 6A to 6H show process for gluing fire-resistant decorative laminate (or high pressure decorative laminate) onto the doorframe according to the present invention.

### DETAILED DESCRIPTION

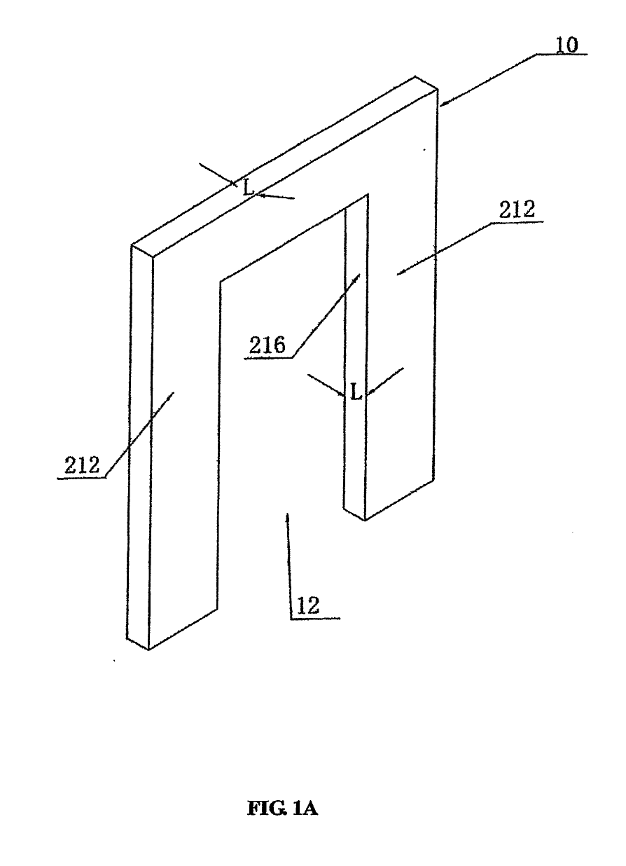

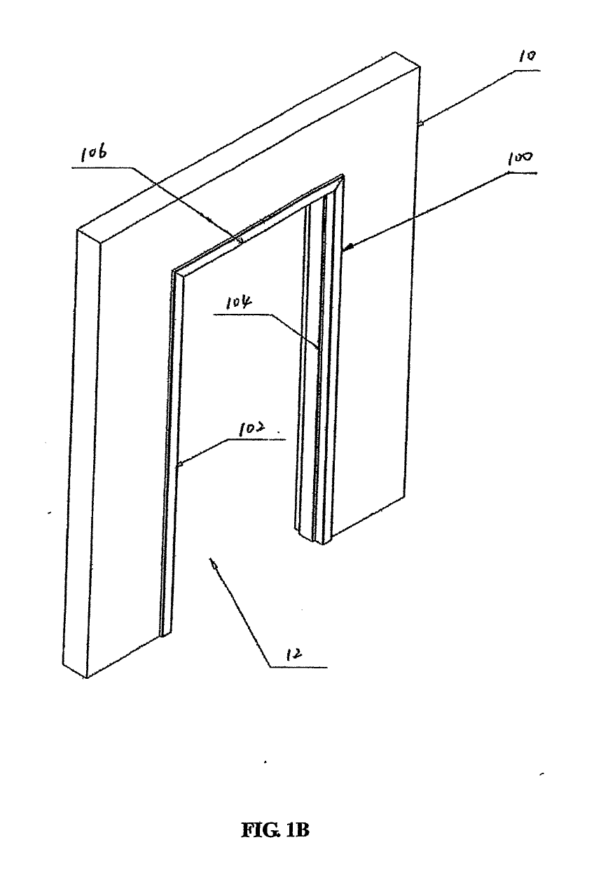

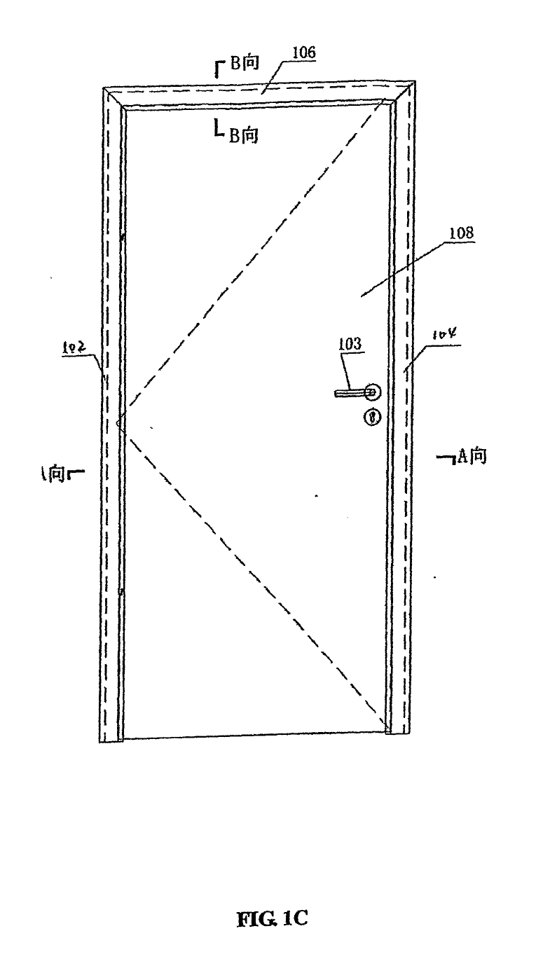

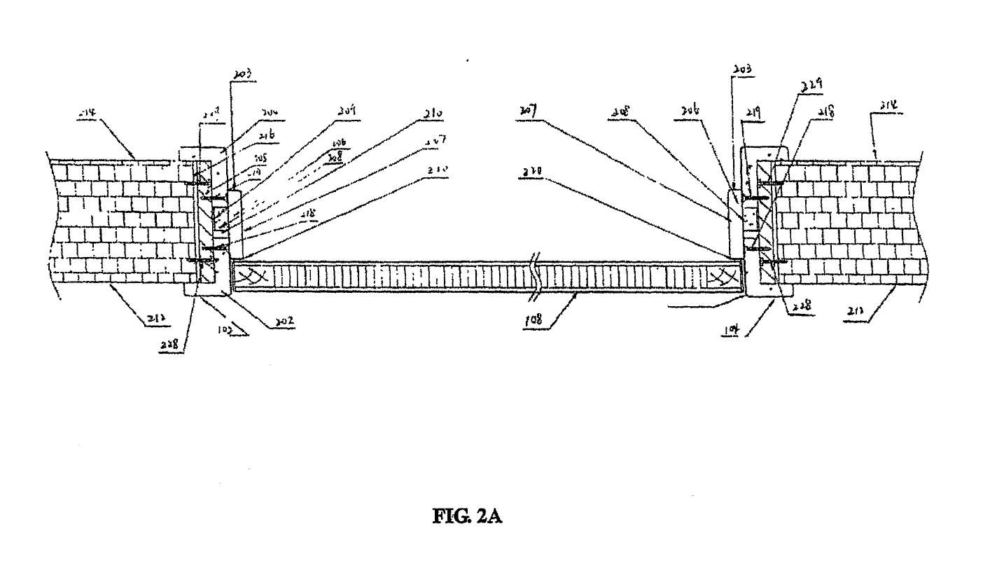

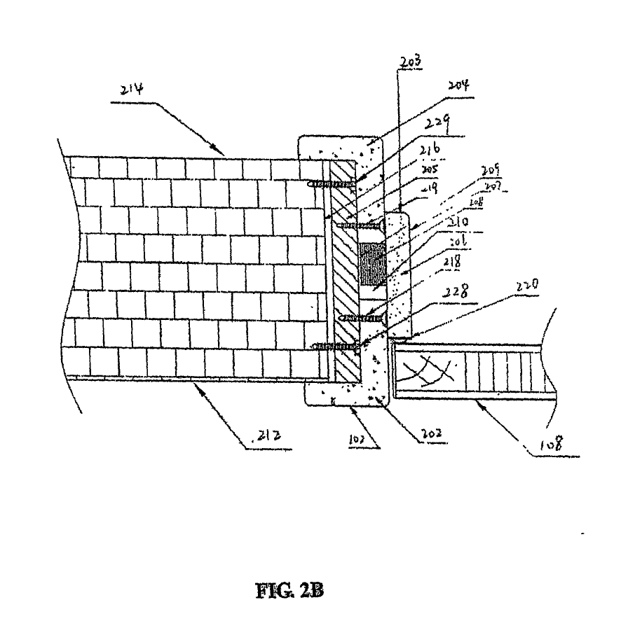

FIG. 1A is a perspective view of wall-body 10. The wall-body 10, with a doorway 12 on it, has a front wall-body 212, a rear wall-body 214 and a side wall-body 216. The rear wall-body 214 is not shown in FIG. 1A because it is behind the front wall-body 212 thus being shielded by the front wall-body 212. The rear wall-body 214 is clearly shown in FIGS. 2A and 2B.

FIG. 1B is a perspective view of the doorframe 100 that is installed into the doorway 12 of the wall-body 10 according to the present invention. As shown in FIG. 1B, the doorframe 100 comprises a left doorframe post 102, a right doorframe post 104 and a transverse doorframe post 106 that are installed into the doorway 12.

FIG. 1C is a front view of the doorframe 100, within which a door 108 is installed, in accordance with the present invention. As shown in FIG. 1C, the door 108 is movably installed within the left doorframe post 102, the right doorframe 104 and the transverse doorframe post 106. The door 108 can be movably mounted on the left doorframe post 102 by using two or more hinges (not shown in FIG. 1C). A handle 103 is mounted on the door 108. Therefore, by using the handle 103, the door 108 can be rotated inward to be closed or rotated outward to be opened around the left doorframe post 102.

FIG. 2A is a section view along section line A-A in FIG. 1C. At the left hand of FIG. 2A is a section view of the left doorframe post 102 along section A-A line, at the right hand of FIG. 2A is a section view of the right doorframe post 104 along section line A-A, and in the middle of FIG. 2A is a section view of the door 108 along section line A-A.

FIG. 2B is a section view of the transverse doorframe post 106 and the door 108 along section line B-B in FIG. 1C.

As can be seen from FIGS. 2A and 2B, the section view of the left doorframe post 102, the right doorframe post 104 and transverse doorframe post 106 are the same (or symmetrical) in structure. For the simplicity of describing the present invention, each of the three doorframe posts (102, 104 and 106) can be generally referred to as a doorframe post. Therefore, in this specification, same components in all three doorframe posts (102, 104 and 106) will use the same reference numbers, and the description of a component in any one of the three doorframe posts (102, 104 or 106) is deemed as the description to the corresponding components in the other two doorframe posts.

As shown in FIGS. 2A and 2B, a cushion plate 205 is mounted on the side wall-body 216 by using a pair of screws 228 and 229. The cushion plate 205 has two functions. One function is used as an installation base for a doorframe assembly so as to control levelness and verticality and to control dimensional accuracy in installing the doorframe assembly. The other function is used for mounting individual components of a doorframe. Because the cushion plate 205 is made of woods or of the materials having properties similar to woods, it can be easily cut to fit the thickness of side wall-body 216.

The left doorframe post 102 (the right doorframe post 104 or the transverse doorframe post 106) comprises a doorframe post front portion 202, a doorframe post rear portion 204 and a doorframe post middle portion 207. Each of front portion 202 and rear portion 204 has an L-shaped transverse section while the doorframe post middle portion 207 has a T-shaped transverse section. In installation, the doorframe post front portion 202 is amounted at the joint corner of the front wall-body 212 and the side wall-body 216, and the doorframe post rear portion 204 is mounted at the joint corner of rear wall-body 214 and the side wall-body 216. The cushion plate 205 is disposed between the side wall-body 216 and the back sides of the doorframe post front portion 202 and the doorframe post rear portion 204.

As shown in FIGS. 2A and 2B, the doorframe post front portion 202 and the doorframe rear portion 204 are mounted on the cushion plate 205 by a pair of screws 218 and 219, respectively. The cushion plate 205 is in turn mounted on the side wall-body 216 by a pair of crews 228 and 229. If the side wall-body 206 is thicker, more crews may be used to mount the doorframe post front portion 202, the doorframe rear portion 204, and the cushion plate 205.

As shown in FIGS. 2A and 2B, when the doorframe post front portion 202 and the doorframe post rear portion 204 are mounted on the side wall-body 216, there formed a gap 209 between the doorframe post front portion 202 and the doorframe post rear portion 204.

The transverse section of the doorframe post middle portion 207 is in a T-shape. The length of upper half part 206 of the doorframe post middle portion 207, namely the horizontal part of the T-shape, is longer than that of the gap 209. The length of the lower half part 208 of the doorframe post middle portion 207, namely the vertical part of the T shape, is shorter than that of the gap 209. Thus, when the lower half part portion 208 of the doorframe post middle portion is inserted into gap 209, the upper half part 207 of the T-shape can tightly contact the surface of the doorframe post front portion 202 and the doorframe post rear portion 204, thus covering the holes formed by the screws 218 and 219 so as to enhance the strength and the artistic appearance of the doorframe post 102. As shown in FIG. 2A, the lower half part 208 of the T-shape contacts the side of the doorframe post rear portion 204 within the gap 209. This way, when the door 108 is closed to contact the side of the doorframe post middle portion 207, the doorframe middle portion 207 can still be stably mounted in the gap 209. The doorframe post middle portion 205 can be adhesively mounted in the gap 209.

Because the length of the lower half part 208 of the T-shape is shorter than that of the gap 209, a space 210 will be formed in the gap 209. When the space 210 changes its length, the doorframe manufactured in accordance with the present invention can fit side wall-body 216 having different thickness. Of cause, if the length of the lower half part 208 of the T-shape is substantially equal to that of the gap 209, the doorframe post middle portion 207 can also be inserted into the gap 209.

After the doorframe post middle portion 207 is mounted in its position, a stage 203 is formed because the upper half part 206 of the T-shape is above the surface of the doorframe post front portion 202 and the doorframe post rear portion 204. When the door 108 is closed in contacting the stage 203, the stage 203 can prevent the door 108 from continuously rotating forward. Therefore, the door frame post middle portion 207 not only has a function of accommodating wall-bodies having different thicknesses, but also has the function of stopping the door 108 at a desired position when it is closed, thus simplifying the structure of the doorframe. The manufacturing simplicity is one of the advantages of the present invention.

In addition, the upper half part 206 of the T-shape has a seal strip 220 at the side that contacts the door 108. Therefore, when the door 108 is closed to contact the upper half part 206 of the doorframe post middle portion 207, the seal strip 220 has the function to seal the front surface of the door 108.

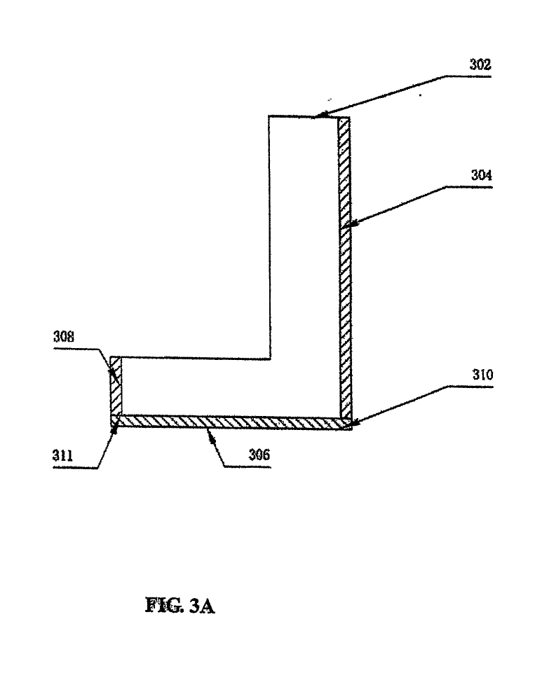

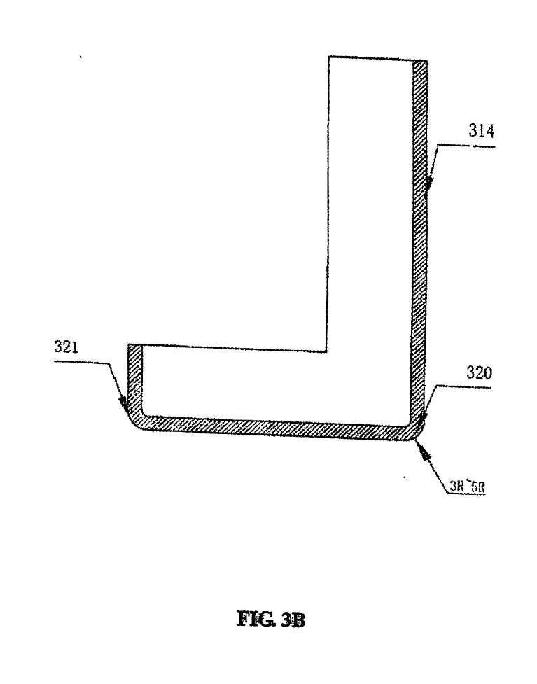

To enhance the strength and artistic appearance of a doorframe fire-resistant decorative laminates (or high pressure decorative laminates) are usually disposed around its outside surfaces. FIG. 3A shows a portion of the section view of a traditional doorframe, around which three separate sheets of high pressure decorative laminates 304, 306 and 308 are adhesively disposed. The traditional method of adhesively disposing three separate sheets of the fire-resistant decorative laminates (or high pressure decorative laminates) around its outside surfaces, especially after the doorframe post has been installed into a side wall-body, makes manufacturing process complicate and installation cost high. Furthermore, because the prior art doorframe uses three separate sheets of the fire-resistant decorative laminates (or high pressure decorative laminates) to be the outside surfaces for its doorframe post, it is unavoidable to form right angles around the corners (310, 311) between the joint section of two sheets of the fire-resistant decorative laminates (or high pressure decorative laminates). These right angles may have negative effect on artistic appearance and on safety to use the doorframe.

FIG. 3B shows the L-shaped transverse section of the doorframe front or rear portion (202 or 204) of the doorframe post 102, 104 or 106 according to the present invention, where the L-shaped transverse section is adhesively wrapped by one sheet of fire-resistant decorative laminate (or high pressure decorative laminate) before the doorframe post is installed into the doorway of a side wall-body. As shown in the FIG. 3B, two arcs 320 and 321 are formed around two corners on the L-shaped section view of the doorframe post front or rear portion (202 or 204). Because of these two arcs 320 and 321, it is possible to adhesively wrap one sheet of the fire-resistant decorative laminate (or high pressure decorative laminate) around the doorframe post front or rear portion (202 or 204). The method of adhesively mounting one sheet of fire-resistant decorative laminate (or high pressure decorative laminate) around a doorframe post, especially before the doorframe is installed into the doorway of a side wall-body, makes the adhesive mounting process simpler, thus reducing the installation cost for doorframes. In addition, the two arcs 320 and 321 formed around two corners on the L-shaped section make the doorframes to have better artistic appearance and improve the safety to use the doorframes. In the present invention, the arc 320 or 321 can be selected between 3R to 5R or the arc can be selected as 4 mm.

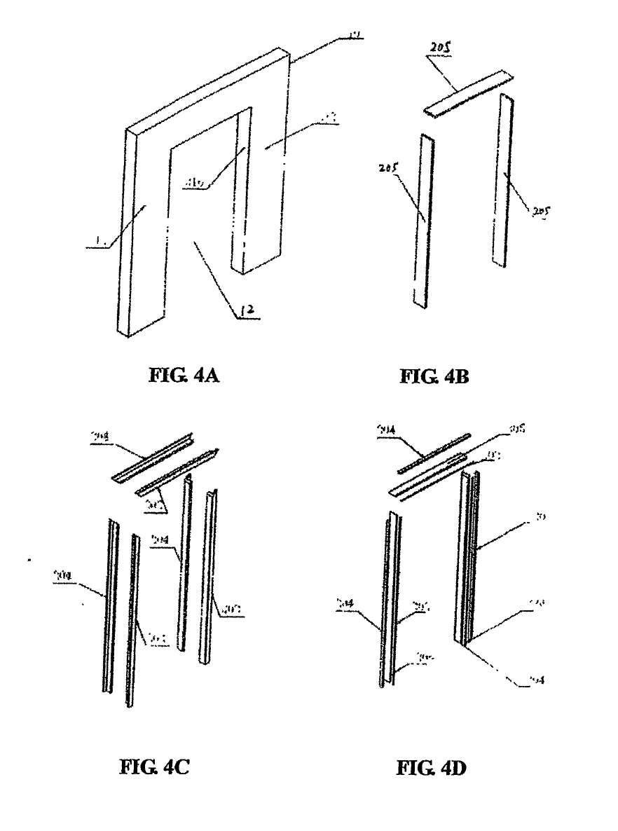

FIGS. 4A, 4B, 4C and 4D are installation diagrams for assembling a doorframe assembly according to the present invention.

As shown, FIG. 4A is a perspective view of the wall body 10 having the doorway 12, on which the doorframe of the present invention can be mounted; FIG. 4B is a perspective view illustrating the installation positions of the cushion plate 205 according to the present invention; FIG. 4C is a perspective view illustrating the installation positions of the doorframe front and rear portions (202 and 204) of the doorframe posts (102, 104 and 106); FIG. 4D is a perspective view illustrating the installation positions of the doorframe front portion and rear portion (202 and 204) of the doorframe posts (102, 104 and 106) relating to the cushion plates 205.

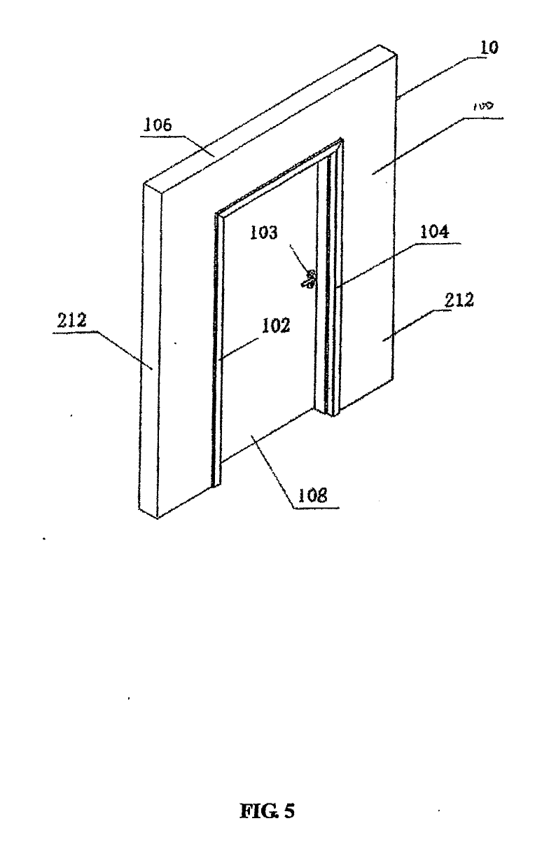

FIG. 5 is a perspective view to show that the door 108 and doorframe 100 have been installed into the doorway 12 on the wall-body 10 according to the present invention.

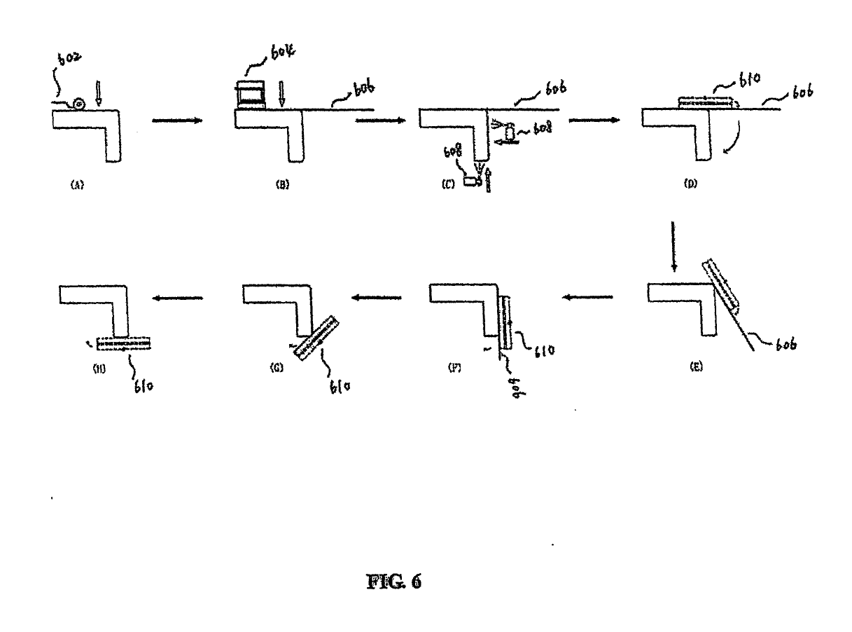

FIGS. 6A-6H show the process for adhesively mounting a sheet of fire-resistant decorative laminate (or high pressure decorative laminate) around a doorframe post front or rear portion (202 or 204).

As shown in FIG. 6A, a glue brushing device 602 wipes a glue coating on the upper horizontal outside-surface of a doorframe post front or a rear portion (202 or 204).

As shown in FIG. 6B, the press-plate (not shown) of a cold-press machine 604 presses a sheet 606 of fire-resistant decorative laminate (or high pressure decorative laminate) against the upper horizontal outside-surface of the doorframe post front or the rear portion (202 or 204) so that the sheet can be adhesively mounted on the upper horizontal outside surface.

As shown in FIG. 6C, a glue spraying device 608 sprays a glue coating on the vertical outside-surface and the bottom outside surface of the doorframe post front or the rear portion (202 or 204).

As shown in FIG. 6D, a heating-press-plate 610 is moved to the upper corner position against the sheet 606 preparing for bending the sheet 606 around the upper corner of the doorframe post front or the rear portion (202 or 204).

As shown in FIG. 6E, the heating-press-plate 610 presses the sheet 606 to force it around the upper corner of the doorframe post front or the rear portion (202 or 204).

As shown in FIG. 6F, the heating-press-plate 610 presses the sheet 606 against the vertical outside-surface of the doorframe post front or the rear portion (202 or 204) so that the sheet 606 can be adhesively mounted on the vertical outside-surface.

As shown in FIG. 6G, the heating-press-plate 610 presses the sheet 606 to force it around the lower corner of the doorframe post front or the rear portion (202 or 204).

As shown in FIG. 6H, the heating-press-plate 610 presses the sheet 606 against the bottom outside surface of the doorframe post front or the rear portion (202 or 204) so that the sheet 606 can be adhesively mounted on the bottom outside surface.

It should be noted that in FIG. 3B two arcs 320 and 321 are formed around two corners on the L-shaped section view of the doorframe post front or the rear portion (202 or 204). It is because of these two arcs 320 and 321 that make it possible to use the process as shown in FIGS. 6 A-H to adhesively mount one sheet of fire-resistant decorative laminate (or high pressure decorative laminate) around the doorframe post front or the rear portion (202 or 204). Without these two arcs 320 and 321, a sheet of the fire-resistant decorative laminate (or high pressure decorative laminate) would be broken or damaged around the corner of the doorframe post front or rear portion in the process as shown in FIG. 6A-H.

While in the forgoing specification this invention has been described in relation to certain specific embodiments, and many details have been set forth for purpose of illustration, it will be apparent to those skilled in the art that certain of the details described here can be varied considerably without departing the basic principles of the invention.

1. A doorframe assembly for being mounted into a wall-body, comprising a left doorframe post, a right doorframe posts and a transverse doorframe post, said each of the three doorframe posts comprising:
a doorframe post front portion having an L-shaped transverse section;
a doorframe post rear portion having an L-shaped transverse section;
a doorframe middle portion having a T-shaped transverse section;
wherein the wall-body has a doorway defined by a front wall-body, a rear wall-body and a side wall-body;
wherein the doorframe post front portion is mounted around the corner at the joint section of the front wall-body and the side wall-body;
wherein the doorframe post rear portion is mounted around the corner at the joint section of the rear wall-body and the side wall-body; and
wherein the doorframe post middle portion is installed between the doorframe post front portion and the doorframe post rear portion.

2. The doorframe assembly of claim 1, wherein the T-shaped transverse section of the doorframe post middle portion further comprising:
an upper half part and a lower half part; wherein the length of the upper half part is longer than that of the gap and the length of the lower half part is shorter than that of the gap;
wherein the upper half part is mounted above the surface of the doorframe post front portion and the doorframe post rear portion; and
wherein the lower half part is inserted into the gap.

3. The doorframe assembly of claim 2, wherein after the lower half part is inserted into the gap, there is a space in the gap.

4. The doorframe assembly of claim 2,
wherein a door is installed in the doorframe assembly; and
wherein the upper half part forms a stage above the surface of the doorframe post front portion and the doorframe post rear portion so as to stop the door from moving forward when the door contacts the stage.

5. The doorframe assembly of claim 4,
wherein a seal strip is disposed on the upper half part of the doorframe post middle portion at the side that contacts the door.

6. The doorframe assembly of claim 1, further comprising:
a cushion plate that is disposed on the side wall-body under the doorframe post front portion and the doorframe post rear portion.

7. The doorframe assembly of claim 6, further comprising:
a pair of screws for mounting the cushion plate on the side wall-body.

8. The doorframe assembly of claim 7, further comprising:
a pair of screws for mounting the doorframe post front portion and the doorframe post rear portion onto the cushion plate.

9. The doorframe assembly of claim 8,
wherein the upper half part covers the pair of screws when the upper half is mounted into the gap.

10. The doorframe assembly of claim 1,
wherein a first arc is formed at a first corner of the L-shaped transverse section of the doorframe post front portion, the doorframe post rear portion or the doorframe middle portion.

11. The doorframe assembly of claim 10,
wherein a second arc is formed at a second corner of the L-shaped transverse section of L-shaped transverse section of the doorframe post front portion, the doorframe post rear portion or the doorframe middle portion.

12. The doorframe assembly of claim 11,
wherein the first arc and the second arc is from 3R to 5R.

13. The doorframe assembly of claim 11,
wherein the first arc or the second arc is 4 mm.

14. The doorframe assembly of claim 11,
wherein a sheet of fire-resistant decorative laminate (or high pressure decorative laminate) is adhesively amounted around the outside surface of the L-shaped transverse section of the doorframe post front portion, the doorframe post rear portion or the doorframe middle portion.
